(19) United States
(12) Patent Application Publication
(10) Pub. No.: US 2005/0033492 A1
(43) Pub. Date: Feb. 10, 2005

(54) System and method for safety and financial monitoring of motor vehicles

(76) Inventors: Alan Mendelson, West Hartford, CT (US); Leon Pintsov, West Hartford, CT (US)

Correspondence Address: Timothy A. Johnson;McCormick, Paulding & Huber, LLP, City Place II, 185 Asylum Street, Hartford, CT, 06103, US

(21) Appl. No.: 10/782,561

(22) Filed: Feb. 19, 2004

Related U.S. Application Data
(60) Provisional application No. 60/493,394, filed on Aug. 7, 2003.

(51) Int. Cl. G06F 19/00

(52) U.S. Cl. 701/35; 701/29; 340/438

(57) ABSTRACT

The present invention is a system for monitoring and recording for later use values pertaining to the parameters of a subject motor vehicle. The monitoring and recording system includes a plurality of sensors capable of automatically measuring vehicle parameters and a system clock, both of which are in communication with a system computer. The system computer is capable of displaying and/or recording the data that is obtained (either automatically or manually) on a monitor or computer-readable medium for later use, respectively. The system can be used, for example, to monitor driving styles or to verify or detect infractions committed by the operator of the subject motor vehicle. In some embodiments, the monitoring and recording system is installed in the subject motor vehicle.

### CROSS REFERENCE TO RELATED APPLICATIONS

This application claims priority to a prior U.S. provisional application Ser. No. 60/493,394 filed on Aug. 7, 2003 entitled “System and Method for Safety and Financial Monitoring of Motor Vehicles”, which is incorporated herein by reference.

### BACKGROUND OF THE INVENTION

1. Technical Field

The present invention relates to car monitoring systems in general, and to a car monitoring system that monitors and records certain parameters of a motor vehicle for later use, in particular.

2. Background Information

Motor vehicles are one of the most widely used forms of transportation. They are operated by millions of drivers, both professional and amateurs. Cars, trucks, SUVs, and other motor vehicles provide many advantages for those who use them for business and/or leisure purposes. For example, motor vehicles enable people to move themselves and cargo from place to place quickly with minimal physical effort.

However, motor vehicles also have disadvantages. For example, they are expensive to own and operate. In particular, motor vehicles used for business purposes pose certain distinct problems. On one hand, they are operated by employees or agents, yet on the other hand, it is the employer that pays the expenses and bears much of the liability for any damage caused by the vehicle. Furthermore, it is especially important for employers to accurately monitor expenses associated with purchase and maintenance of such vehicle because many expenses are tax deductible.

Motor vehicles also pose difficulties for federal, state and municipal authorities (generally referred to as “government”) that must impose a variety of rules and regulations on operation and financial reporting of motor vehicles. These rules and regulations are usually enforced by law enforcement agencies (state, municipal and federal) and financial audit and control agencies such as IRS and state/municipal departments of revenue collections. The enforcement of government-imposed regulations is generally very time and resource consuming for a variety of rather obvious reasons. For example, enforcement of speed limits on state, federal and local roads in USA require thousands of police cars in order to effectively monitor and control the speed of motor vehicles on the roads. Direct labor and material cost of such checks and controls, alone, is measured in the millions and millions of dollars. Furthermore, when violations are detected, the process (as employed today) results in a loss of time and productivity by workers.

Similarly, financial controls are based on estimates and are very difficult to verify for financial authorities. The end result, as it has already been mentioned above, is an extremely costly and inefficient system that makes very poor and insufficient use of available information technology resources.

Modern motor vehicles are equipped with a variety of sensors and a general computer system capable of processing sensory data in real time in order to control actuators. Actuators are designed to perform mechanical action under control of computer system such as for example slowing and accelerating controlled vehicle depending on the road and traffic conditions. The history of “computerization” of motor vehicles goes back to mid-seventies when car manufacturers worldwide begin to realize an enormous potential of newly invented microprocessor.

However, most of the creative energy of car manufacturers went into inventing and designing systems that can improve safety, efficiency, performance and driving experience for car owners and operators.

The object of present invention is to bring the power and ease of use of modern technology to dramatically improve administration and control of motor vehicles by both private users and businesses, and government agencies. The monitoring and recording system of the present invention disclosed below is intended to overcome these and other difficulties of the prior art.

### DISCLOSURE OF THE INVENTION

According to the present invention, a system for monitoring and recording the parameters of a subject motor vehicle includes a monitoring system that includes a system clock and a plurality of automatic sensors for measuring vehicle parameters. At least one of the sensors is a distance sensor that measures the distance to other motor vehicles in front of the subject motor vehicle when moving. The monitoring and recording system further includes a CPU in communication with the system clock and the plurality of sensors that includes a cryptographic co-processing unit, a non-volatile internal memory unit, and an external memory device. The system is capable of encrypting data received and processing and recording the encrypted data for later use according to a program stored in the CPU.

According to one aspect of the present invention, the above-described monitoring system may be installed in the subject motor vehicle.

An advantage of the present system is that when an operator of a motor vehicle is stopped and fined by a law enforcement officer for an alleged violation of the speed limit, the operator may “interrogate” his/her motor vehicle information capturing and recording system. The interrogation can aid the user in defending or confirming a claim by enabling the user to determine the exact speed, or other relevant parameter, of the vehicle at the time of the alleged violation(s).

Another advantage of the present system is that when an operator of a vehicle with multiple and potentially serious infractions a judicial authority may require the prior offender to install the system of present invention in his/her vehicle. The system automatically enables the judicial authority to capture, store and report the subject motor vehicle's performance at any desired interval of time to law enforcement authorities to ensure that the operator is driving “safely”.

A further advantage of the present system is that when an operator of a vehicle that is used for business purposes the operator can “interrogate” vehicle information system and obtain a computerized record of all relevant expense parameters. The expense parameters are automatically and efficiently incorporated into a financial document, such as an expense report or the annual tax return.

An even further advantage of the present system is that one (e.g., an employer or insurance company) retrieving data can determine whether or not the operator of the motor vehicle was driving in a reckless manner (e.g., driving at excessive speeds relative to the speed limit and/or “tailgating”).

The above and other objects and advantages of the present invention will be apparent upon consideration of the following detailed description taken in conjunction with accompanying drawings.

### BRIEF DESCRIPTION OF THE DRAWINGS

FIG. 1 is a schematic diagram of the motor vehicle equipped with sensors capable of collecting digital sensory data and communicating the data to the vehicle system computer.

FIG. 1A is a schematic diagram of the system computer shown in FIG. 1.

FIG. 2 is a flow chart of the process of recording and outputting information collected by the motor vehicle of FIG. 1.

FIG. 3 is a flow chart of the retrieval process for obtaining the information recorded in the process outlined in FIG. 2.

FIG. 4 is a flow chart of the manual process of verifying of the (specific record) information collected according to the process of FIG. 2 and of creating actionable information reports for various users and participants in the overall infrastructure for motor vehicle management system.

FIG. 5 is a flow chart of the process of automatic verification of vehicle′ collected information against the database of rules and regulations

### DETAILED DESCRIPTION

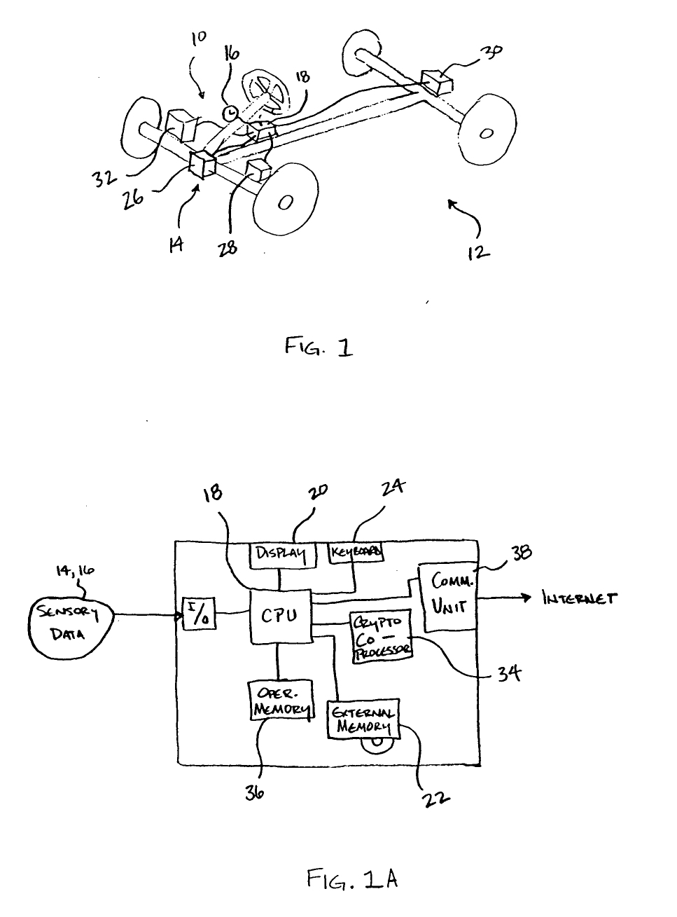

Referring to FIG. 1, the present invention is a system 10 for monitoring and recording for later use values pertaining to certain parameters of a motor vehicle 12. The monitoring and recording system 10 includes a plurality of sensors 14 for measuring vehicle parameters and a system clock 16, both of which are in communication with a system computer 18. The system computer 18 records the data on external memory 20, such as a CD, DVD or other computer-readable medium, for later use, or displays the data, for example, on a display 22, such as a monitor. In some embodiments, the system computer 18 may also include a manual input option system (e.g., a keyboard) 24 and/or may be connected to a printer (not shown) for generating a hard copy of the recorded information. According to another aspect of the invention, the monitoring and recording system 10 is installed in a subject motor vehicle 12.

Referring to FIGS. 1 and 1A, the system clock 16 is in communication with the system computer 18 and provides a time reference for the monitoring and recording system 10. Time (t), as measured by the system clock 16, is a moment of time measured in reference to any standards (e.g. Greenwich time).

The plurality of sensors 14 provided with the present monitoring and recording system 10 may include a speed sensor 26, a GPS sensor 28, a fuel consumption sensor 30 and a distance sensor 32 (i.e., a sensor for the purpose of measuring the distance to other motor vehicles in front of the subject motor vehicle when moving). The above list of sensors is not exhaustive, but rather is exemplary. For example, the present invention can include further sensors that measure known parameters of a motor vehicle, such as data pertaining to acceleration and deceleration.

The plurality of sensors 14 may capture data at any pre-determined time interval. For example, a common interval is one-second; however, shorter or longer intervals are also acceptable. In addition, various sensors may capture data at time intervals different than other sensors, depending on need. Even further, the time intervals for certain sensors may remain dynamic. In other words, the time interval at which data is taken for one sensor, such as the distance sensor 32, may vary depending on the values obtained from another sensor, such as the speed sensor 26.

Global Positioning Systems (“GPS”) sensors 28 are commercially available and place the system 10 in communication with a GPS satellite system. Together, the longitude and latitude of the subject motor vehicle 12 can be obtained at any point in time (t). Therefore, the GPS sensor 28 can provide the system computer 18 with position data of the subject motor vehicle 12 at any instant in time.

The speed sensor 26 measures the subject motor vehicle's 12 speed as a function of time and geographical location V (t, lg, lt), where t is a moment of time measured in reference to the system clock 16. In some embodiments, several measurements obtained from the GPS sensor 28 may used to calculate speed at predetermined intervals based on the change in position over an interval of time. Alternatively, various speedometers may be used in conjunction with the GPS system to match the instantaneous speed of the motor vehicle with the subject motor vehicle's 12 location.

The fuel consumption sensor 30 measures fuel consumption as a function of time, average consumption over predetermined period of time, or consumption linked to two or more specific locations (as identified by their longitude and latitude). The fuel consumption sensor has particular utility in determining the need for maintenance, as well as in interpolating certain driving style parameters (e.g., excessive acceleration).

The distance sensor 32 measures the distance to a vehicle in front of the subject motor vehicle 12 as a function of time, longitude and latitude during operation (i.e., when the subject motor vehicle 12 is moving). The distance sensor 32 has particular utility in determining if the operator of the subject motor vehicle 12 is, among other things, driving dangerously (e.g., “tailgating”).

Referring to FIG. 1A, the system computer 18 may also include an input device 24, such as a keyboard, for the manual input of data. For example, it may be desirable to input the type and time of maintenance procedures performed on the subject motor vehicle 12 and is inputted by a mechanic, or other person, performing the maintenance procedure. It has to be expressly noted that the above example of an inputable parameter is not exhaustive. Rather, the system computer 18 can process any manually inputable information, as required. In addition, there exist numerous devices for the manual input of data in addition to a keyboard. For example, a joystick, a computer mouse and a touch screen monitor are also known to enable a user to input data into a computer.

The system computer 18 is in communication with the plurality of sensors 14 and manual input device(s) 24 enumerated above, as well as with the system clock 16. The system computer 18 includes a central processing unit (or “CPU”) 33, a cryptographic co-processing unit 34, a non-volatile internal memory unit 36, an output display 22, and, in some embodiments, a communication unit 38 and/or a printer (not shown). In addition, the system computer 18 is in communication with an external memory device 20.

The CPU 33 is capable of processing digital information according to the program stored in its operating memory (i.e., the loaded software).

The cryptographic co-processing unit 34 is designed to execute cryptographic transformation (encryption, digital signatures) operatively and securely connected to non-volatile memory unit 36 capable of storing a (secret) key.

The non-volatile internal memory unit 36 is capable of storing a required amount of information in such a way that any unauthorized attempt to alter its content results in (detectable) destruction of memory content. The non-volatile memory unit 36 may have a separate storage for a secret cryptographic key that can be used to encrypt the data and can be displayed or stored in the external memory unit 20.

The external memory unit 20 is capable of storing/recording a required amount of information on a computer readable medium, as well. For example, CD-ROM, DVD, smart card, floppy diskette or the like, are all examples. The external memory unit 20, together with optional communication unit 38, is in communication with the CPU 33, as shown in FIG. 1A.

The output display 22, such as a monitor or LCD screen, is in communication with the CPU 33 and operative to allow the vehicle's operator to control vehicle's computer and/or view obtained data.

The optional communication unit 38 is capable of transmitting data from the subject motor vehicle 12 system computer 18 to any desired computer system via public (or private) communication network, such as via telephone, LAN, WAN, Internet, or the like.

It must be also expressly noted that the necessary information capacity of the subject motor vehicle 12 system computer 18 is entirely within the limits of the present state of information technology. For example, in order to store a single unit of vehicle speed data from the speed sensor 26, the system computer 18 would require a relatively small amount of memory. For example, assuming that both longitude and latitude can be expressed as 4 decimal digits, the amount of information needed to represent the vehicle location at any moment in time is less than 4 bytes (8 digits at 4 bits each is equal to 32 bits or 4 bytes).

Likewise, assuming that the vehicle's speed can be represented by 3 decimal digits, it can be then represented in less than 2 bytes. Thus, the total amount of information necessary to represent instantaneous speed of the vehicle at a given location is no more than 6 bytes. Even if the speed is to be recorded 24 hours a day at every second, the total amount of information capacity for a year is 24×3,600×6=518.4 Kbytes. This amounts to 518.4×365 days=189,216 Kbytes or 189 Mbytes of speed data per year. Thus, for example one standard CDR or CD RW memory disk with the capacity 650 Mbytes is able to store more than 3 years of speed record at every second indexed by time stamp (such as TTTTTTDDMMYY, where TTTTTT are the hour, minute, and second, DD is the date, MM is the month and YY is the year). Therefore, a CD-ROM or DVD-based system will provide ample storage for all relevant information for the life of the motor vehicle.

Finally, the information processing system that operates within the IT infrastructure (not shown) of official motor vehicle authorities is traditionally a computer system, such as main frame computer systems. The IT infrastructure is supplied with geographical database of all roads with administrative territory of the motor vehicle authority together with corresponding speed limits and other relevant parameters. It must be expressly noted that the road database is a dynamic one and contains up to the minute information concerning road closures, repairs, modified speed limits and the like and thus it is supplied with an appropriate indication of time such as time stamp.

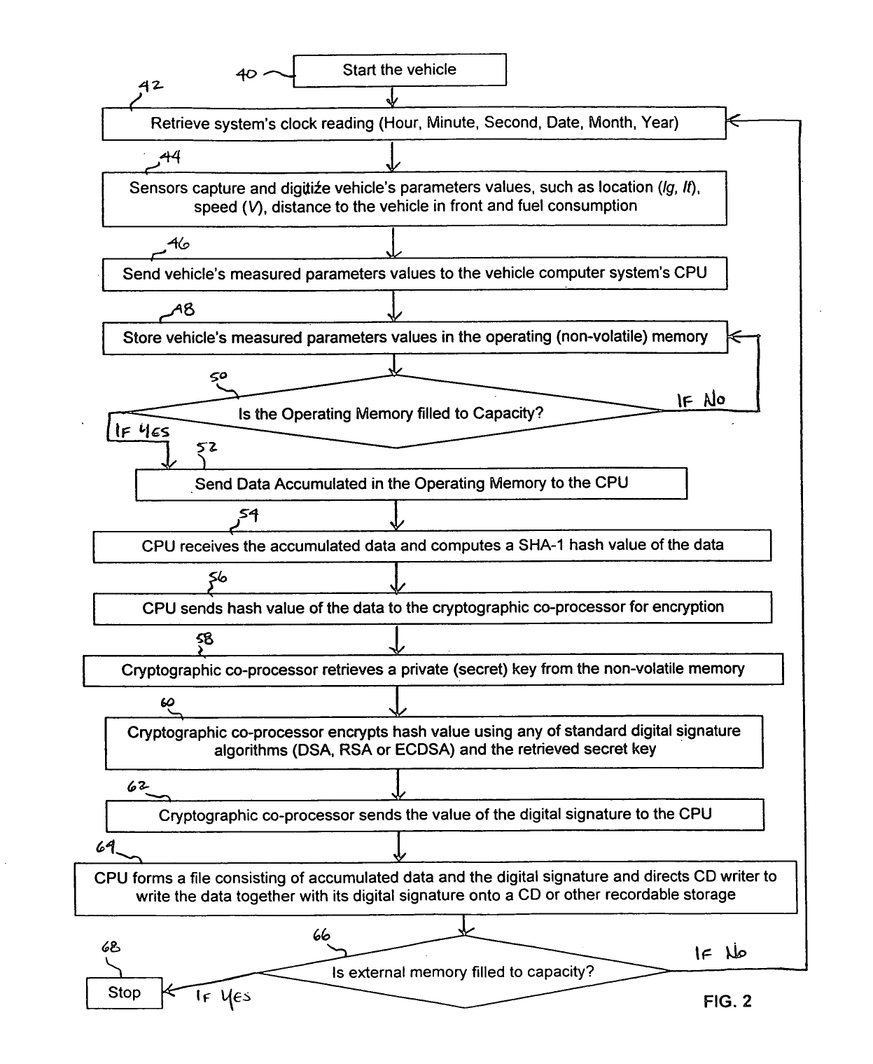

Referring now to FIG. 2, in operation, the system 10 is activated when the subject motor vehicle 12 is started (as indicated by identifier 40). Upon ignition, the plurality of sensors 14 and system clock 16, described above, begin capturing, digitizing and sending information to the system computer 18 at predetermined time intervals (as indicated by identifiers 42, 44, and 46, respectively). The system computer 18 stores the information obtained from the plurality of sensors 14 for each time interval in the non-volatile internal memory unit 36 (as indicated by identifier 48).

Once obtained, the system 10 determines whether the non-volatile internal memory unit 36 is filled to its capacity (as indicated by identifier 50). In the event that the non-volatile internal memory unit 36 is filled to capacity, the subject motor vehicle's 12 parameters remain in the non-volatile internal memory unit 36, as shown in FIG. 2 and as indicated by identifier 48. Assuming that the non-volatile internal memory unit 36 is not filled to capacity, the sensory data is sent to the CPU 33 (as indicated by identifier 52). The CPU 33 receives the accumulated data and computes a hash value of the chunk of data. The hash value is computed according to one of the standard algorithms used in the art (e.g. MD4 or SHA-1) and is sent to the cryptographic co-processor 34 for encryption (as indicated by identifiers 54 and 56, respectively). The cryptographic co-processor 34 encrypts the data according to any of standard digital signatures algorithms used in the art (e.g., DSA, RSA or ECDSA) using a secret key stored in the non-volatile internal memory unit 36, and then sends the value of the digital signature back to the CPU 33 (as indicated by identifiers 58, 60 and 62).

The CPU 33 attaches a digital signature to the chunk of data that was hashed at the previous step and directs the external memory unit 20 to write the data together with its digital signature onto a CD, DVD, or other computer-readable, recordable storage device (as indicated by identifier 64). The system 10 then determines whether the external memory unit 20 is filled to its capacity (as indicated by identifier 66). In the event that the external memory unit 20 is filled to capacity, the system 10 halts, as shown in FIG. 2 and indicated by identifier 68. When the external memory unit 20 is not filled to its capacity, the system 10 repeats itself by retrieving information from the system clock 16 and plurality of sensors 14. The process continues to repeat in the above-described manner until the subject motor vehicle 12 is turned off.

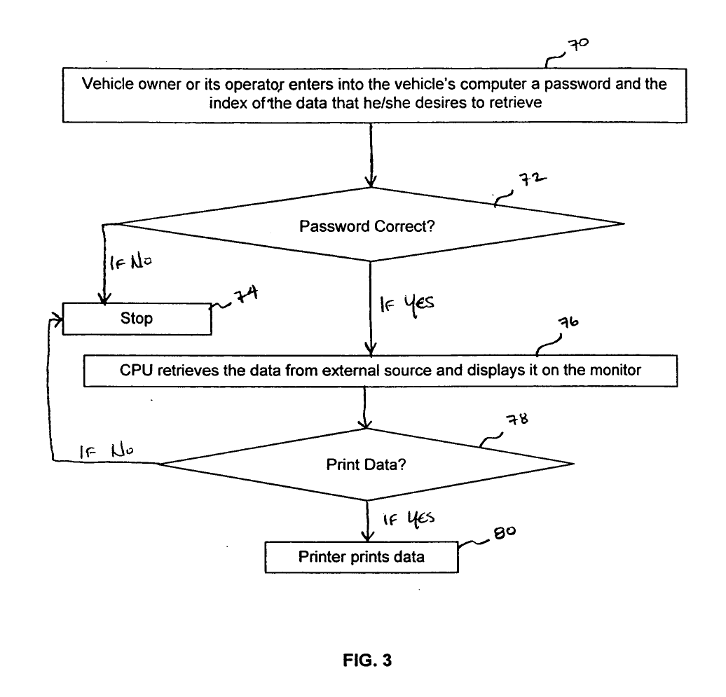

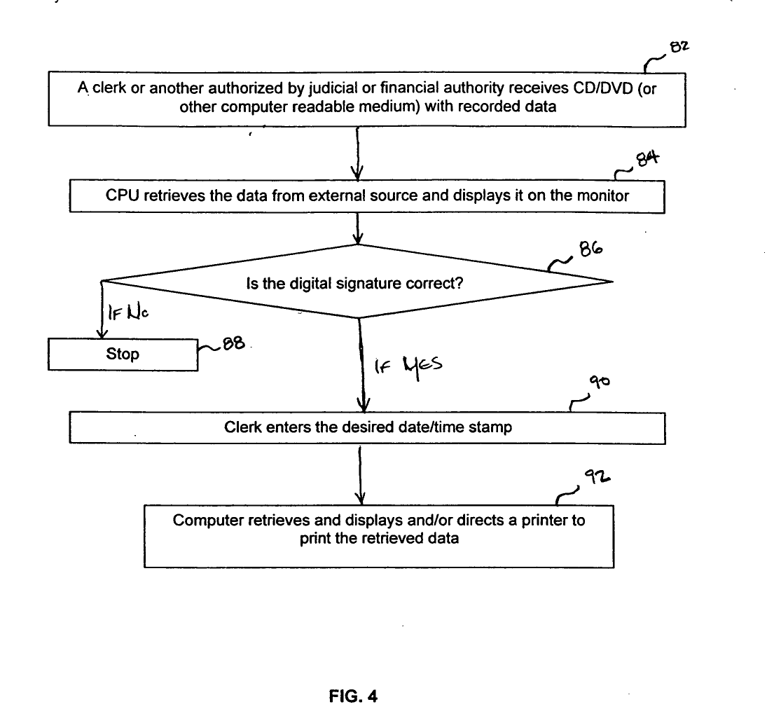

Referring to FIGS. 3 and 4, the information recorded is retrievable. FIG. 3 details one process by which the subject motor vehicle 12 owner may access information stored in the system computer 18. The subject motor vehicle 12 owner or its operator enters, using, for example, the keyboard 24, into the system computer 18 a password and the index of the data that he or she desires to retrieve (as indicated by identifier 70). The index can include any amount of information ranging from a specific date and time to all of the information recorded. The system computer 18 (i.e., the CPU 33) determines whether the password entered is correct (as indicated by identifier 72). If the password is not correct, the information is not retrieved (as indicated by identifier 74). If the password is correct, the information is retrieved and displayed, for example on the monitor 22 (as indicated by identifier 76). The system computer 18 may also prompt the user to print the data using an attached printer (not shown) (as indicated by identifier 78). If desired, the user may print the data on to receive a hard copy (as indicated by identifier 80).

Referring now to FIG. 4, the CD, DVD or any other portable computer readable medium 20 can be physically carried to another computer. For example, the computer readable medium 20 could be delivered to a computer that is at disposal of a judicial authority for data verification or retrieval. Alternatively, if the vehicle′ computer system is equipped with communication unit the desired data can be communicated directly to the desired IP or Internet address via the Internet or other network (e.g., a LAN). The data can also be printed by another computer that can obtains the data recorded by the system 10 in the subject motor vehicle 12.

The detailed description of the process of verifying of the information collected according to the process of FIG. 4 is as follows. A judicial or financial authority in receipt of the information in computer readable form collected by the process described above (either via portable media such as DVD or a CD or through a communication channel) first enters a password and retrieves the (public) key. The (public) key must match the private or secret key that has been used to compute digital signature, as described above (as indicated by identifier 82). The computer used by the judicial or financial authority retrieves the data, and displays it on the monitor where the digital signature can be verified to assure that the data recorded by the vehicle has not been altered (as indicated by identifiers 84 and 86, respectively). In the event that the digital signature is not correct, the data is not displayed (as indicated by identifier 88). Assuming that the digital signature is correct, the stored data then can be displayed and any specific record (e.g. a record of the subject motor vehicle's 12 location and speed on a given date at a given time) can be retrieved and displayed (as indicated by identifier 90 and 92, respectively).

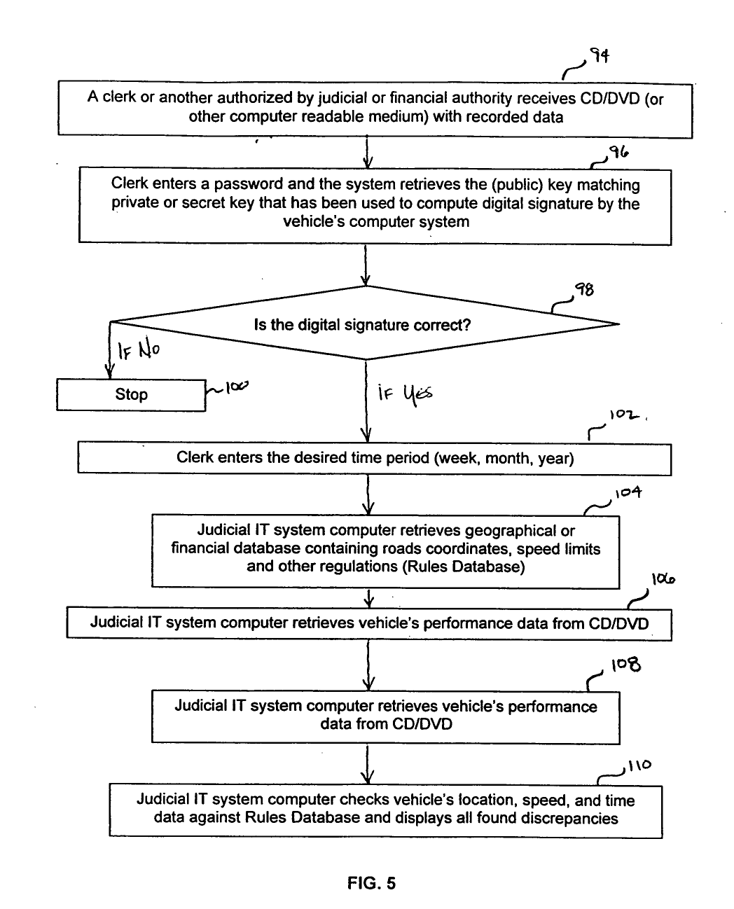

Referring now to FIG. 5, in some embodiments, the data obtained by the system 10 may be combined with software that automatically detects illegal or dangerous driving activity. For example, in these embodiments, a clerk or another authorized by judicial or financial authority receives recorded data from the subject motor vehicle 12 (as indicated by identifier 94). The clerk then enters a password and the computer system of the judicial or financial authority retrieves the (public) key matching private or secret key that has been used to compute digital signature by the subject motor vehicle's 12 system computer 18 (as indicated by identifier 96). The digital signature can be verified to assure that the data recorded by the subject motor vehicle 18 has not been altered (as indicated by identifier 98). In the event that the digital signature is not correct, the data is not displayed (as indicated by identifier 100). However, assuming that the digital signature is correct, the clerk then enters the desired time period (week, month, year) and the data is retrieved (as indicated by identifier 102). The computer system of the judicial or financial authority then retrieves geographical or financial database containing road coordinates, speed limits and other regulations from a database (e.g., Rules Database, described above) (as indicated by identifier 104). The computer system of the judicial or financial authority retrieves vehicle's performance data from the data obtained (e.g., via a CD/DVD) and checks subject motor vehicle's 12 location, speed, and time data against Rules Database (e.g., to determine if the subject motor vehicle disobeyed any traffic laws, and, if so, when and where). All found discrepancies are then displayed (as indicated by identifier 110).

The system of managing passwords and keys can include any of the number of such system well known in the art. It has to be expressly noted that the physical integrity of the vehicle's system computer 18 can be also verified by direct inspection of the subject motor vehicle 12 if required. A law similar to the existing law that makes interference with the vehicle odometer illegal and punishable criminal offence would undoubtedly need to be passed to make interference with subject motor vehicle's 12 recording and monitoring system 10 an illegal offence that is punishable.

While the present invention has been disclosed and described with a reference to the embodiment thereof it will be apparent that variations and modifications as noted above may also be made within the spirit and the scope of the present invention.

1. A monitoring and recording system for a subject motor vehicle, comprising:
a plurality of sensors that monitor and record vehicle parameters of a subject motor vehicle; and
wherein at least one of the plurality of sensors is a distance sensor that measures the distance to motor vehicles in front of the subject motor vehicle at any instant in time.

2. The monitoring and recording system of claim 1 further including a system clock that provides a time reference for the monitoring and recording system.

3. The monitoring and recording system of claim 2, wherein at least one of the sensors is a GPS sensor capable of determining the latitude and longitude of the subject motor vehicle.

4. The monitoring and recording system of claim 2, wherein at least one of the sensors is a speed sensor capable of determining the speed of the subject motor vehicle over any interval of time.

5. The monitoring and recording system of claim 2, wherein at least one of the sensors is a fuel consumption sensor capable of measuring fuel consumption over any interval of time.

6. The monitoring and recording system of claim 2 further including a system computer in communication with the system clock and the plurality of sensors that includes at least a cryptographic co-processing unit the encrypts the data the system computer receives from the plurality of sensors and the system clock.

7. The monitoring and recording system of claim 2, wherein the system computer further includes a non-volatile memory unit that is operable to destroy the data encrypted by the cryptographic co-processor in a detectable manner if an unauthorized attempt to alter the encrypted data is made.

8. The monitoring and recording system of claim 2, wherein the system computer further includes an external memory device, wherein the external memory unit places recorded data on a computer-readable medium.

9. The monitoring and recording system of claim 8, wherein the external memory unit places recorded data on a computer-readable CD ROM.

10. The monitoring and recording system of claim 1 further comprising an input device for the manual input of data.

11. The monitoring and recording system of claim 10, wherein the input device is a keyboard.

12. The monitoring and recording system of claim 1 further comprising an output device.

13. The monitoring and recording system of claim 12, wherein the output device is a monitor.

14. The monitoring and recording system of claim 1 further comprising a communication unit capable of transmitting data from the subject motor vehicle system computer to another computer system via a communication network.

15. The monitoring and recording system of claim 1, wherein the system is installed in the subject motor vehicle.

16. A method for monitoring and recording the parameters of a subject motor vehicle, comprising the steps of:
activating a monitoring and recording system installed in a subject motor vehicle when the subject motor vehicle is started;
capturing, digitizing and sending information measured by a plurality of sensors to a CPU of a system computer at predetermined time intervals, wherein the plurality of sensors includes at least one distance sensor that measures the distance to other motor vehicles in front of the subject motor vehicle and the system computer also includes a cryptographic co-processing unit, a non-volatile internal memory unit, and an external memory device;
storing the information obtained from the plurality of sensors for each of the time intervals in the non-volatile memory unit;
computing a hash value of the chunk of data according to one of the standard algorithms used in the art;
encrypting the hash value in the cryptographic co-processor according to a standard digital signature algorithm using a secret key stored in the non-volatile memory in order to obtain an encrypted value;
sending the encrypted value of the digital signature back to the CPU;
attaching the digital signature to the chunk of data that was hashed; and
directing the external memory device to write the data together with its digital signature onto a computer-readable medium.

17. The method for monitoring and recording the parameters of a subject motor vehicle according to claim 16 further comprising a retrieval process including the steps of:
a user entering a correct password and an index of the data that he or she desires to retrieve;
the CPU verifying the correct password was entered and retrieving and displaying on a monitor the desired information.

18. The method for monitoring and recording the parameters of a subject motor vehicle according to claim 16 further comprising a retrieval process including the steps of:
a judicial or financial authority receiving information collected by the system of the subject motor vehicle in computer readable form on a computer;
the judicial or financial authority entering a correct password and retrieving the public key matching private or secret key that has been used to compute the digital signature; and
the computer verifying the password, retrieving the desired information and displaying the retrieved data on a monitor.

19. The method for monitoring and recording the parameters of a subject motor vehicle according to claim 16 further comprising a retrieval process including the steps of:
a clerk or another authorized by judicial or financial authority receiving data from the subject motor vehicle in computer readable form on a computer;
the clerk entering a correct password into the computer;
the system retrieving a public key matching the secret key that has been used to compute digital signature;
the clerk entering a desired time period during which data was saved;
the computer retrieving information from a geographical or financial database containing regulations from a database;
the computer retrieving the vehicle's performance data from the data received and checking the measured parameters of the subject motor vehicle against the regulations; and
the computer displaying all found discrepancies.
